(19) United States
(12) Patent Application Publication
(10) Pub. No.: US 2014/0115151 A1
(43) Pub. Date: Apr. 24, 2014

(54) ERROR-CAPTURING SERVICE REPLACEMENT IN DATACENTER ENVIRONMENT FOR SIMPLIFIED APPLICATION RESTRUCTURING

(71) Applicant: Empire Technology Development LLC, Wilmington, DE (US)

(72) Inventor: Ezekiel Kruglick, Poway, CA (US)

(73) Assignee: Empire Technology Development LLC, Wilmington, DE (US)

(21) Appl. No.: 13/876,163

(22) PCT Filed: Oct. 14, 2012
(86) PCT No.: PCT/US12/60158

§ 371 Date: Mar. 26, 2013

(51) Int. Cl. H04L 12/26

(52) U.S. Cl. CPC H04L 43/0823
USPC 709/224

(57) ABSTRACT

Technologies are presented for addressing dependency interruptions due to inactivation of a service module in a modular datacenter environment through a diagnostic module. In some examples, the diagnostic module may substitute for one or more inactive service modules in a datacenter architecture. Messages and/or items that are directed to the inactive service module(s) may be intercepted by or rerouted to the diagnostic module and used to generate error reports and/or repair activity triggers.

### BACKGROUND

Unless otherwise indicated herein, the materials described in this section are not prior art to the claims in this application and are not admitted to be prior art by inclusion in this section.

As cloud-based computing becomes more prevalent, cloud applications may become faster and cheaper to implement. In some cases, cloud-based service applications may be built using a number of different datacenter-provided software modular functions. By using software modules already provided by datacenters, cloud applications may be assembled quickly and for relatively low cost. Moreover, since datacenter modules are typically implemented as instances on virtual or physical servers, these modules may be quickly switched in and out of service, allowing applications to be easily and quickly reconfigured.

However, in some situations, this combination of complexity and rapid reconfiguration may lead to module dependency issues. For example, it may be difficult to keep track of what modules require what other modules to be active, especially in cases where the requirements are situation-dependent. These unexpected dependencies may result in a number of undesirable behaviors. For example, unexpected dependencies may cause hard-to-trace errors, or degrade performance due to memory leaks and/or blocked processes awaiting responses from modules that are no longer active. In some cases, unexpected dependencies may even cause security leaks, for example if messages intended for a no-longer-active module are rerouted to unexpected locations.

### SUMMARY

The present disclosure generally describes technologies for error-capturing service replacement in a datacenter environment.

According to some example embodiments, a method for error-capturing service replacement in a datacenter environment may include detecting communication addressed to an inactive service module within a datacenter architecture comprising a plurality of interconnected service modules and reporting the communication addressed to the inactive service module.

According to other example embodiments, a datacenter management service capable of error-capturing service replacement may include a diagnostic module and one or more communication modules configured to facilitate communications between multiple service modules through interconnection channels. The diagnostic module may be configured to detect communication addressed to an inactive service module and report the communication addressed to the inactive service module.

According to further example embodiments, a computer-readable storage medium may store instructions for error-capturing service replacement in a datacenter environment. The instructions may include detecting communication addressed to an inactive service module within a datacenter architecture comprising a plurality of interconnected service modules and reporting the communication addressed to the inactive service module.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter based system where error-capturing service replacement may be employed to simplify application restructuring;

FIG. 2 illustrates use of interconnected modules in conjunction with an example e-commerce web page;

FIG. 3 illustrates an example datacenter module system, where deactivation of a module may result in unrealized dependency;

FIG. 4 illustrates another example datacenter module system, where a diagnosis module may be employed for error-capturing service replacement to simplify application restructuring;

FIG. 5 illustrates a general purpose computing device, which may be used to manage error-capturing service replacement to simplify application restructuring;

FIG. 6 is a flow diagram illustrating an example method that may be performed by a computing device such as the device in FIG. 5; and

FIG. 7 illustrates a block diagram of an example computer program product; all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to error-capturing service replacement to simplify application restructuring.

Briefly stated, technologies are presented for addressing dependency interruptions due to inactivation of a service module in a modular datacenter environment through a diagnostic module. In some examples, the diagnostic module may substitute for one or more inactive service modules in a datacenter architecture. Messages and/or items that are directed to the inactive service module(s) may be intercepted by or rerouted to the diagnostic module and used to generate error reports and/or repair activity triggers.

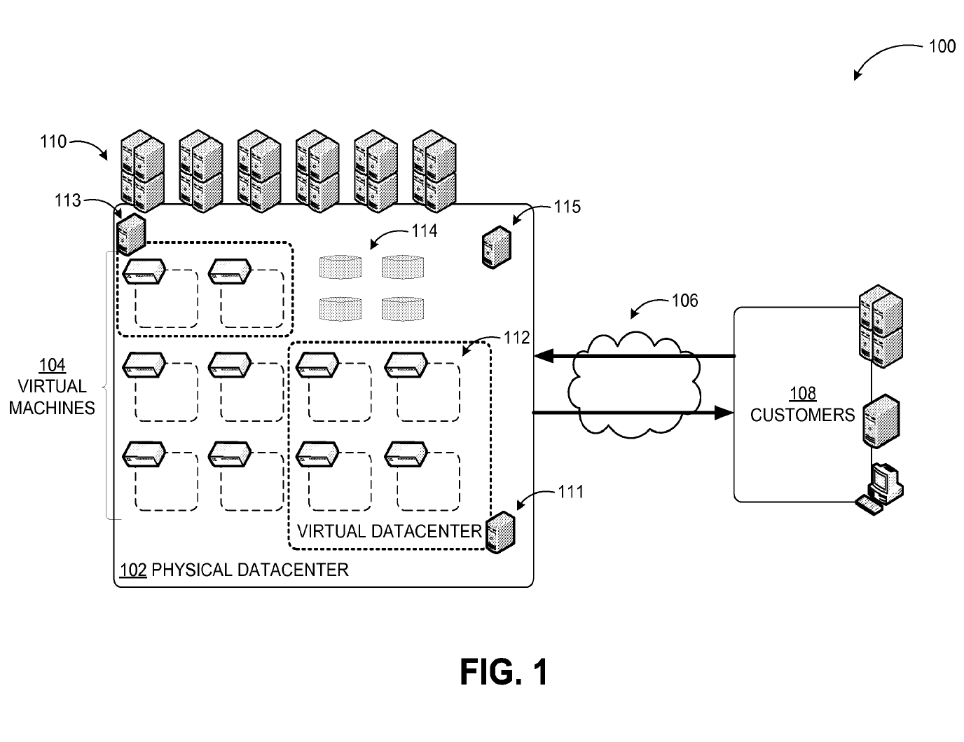

FIG. 1 illustrates an example datacenter based system where error-capturing service replacement may be employed to simplify application restructuring, arranged in accordance with at least some embodiments described herein.

As shown in a diagram 100, a physical datacenter 102 may include one or more physical servers 110, 111, and 113, each of which may be configured to provide one or more virtual machines 104. For example, the physical servers 111 and 113 may be configured to provide four virtual machines and two virtual machines, respectively. In some embodiments, one or more virtual machines may be combined into one or more virtual datacenters. For example, the four virtual machines provided by the server 111 may be combined into a virtual datacenter 112. The virtual machines 104 and/or the virtual datacenter 112 may be configured to provide cloud-related data/computing services such as various applications, data storage, data processing, or comparable ones to a group of customers 108, such as individual users or enterprise customers, via a cloud 106.

The services provided by the virtual datacenter 112 and similar ones may be facilitated through a number of interconnected modules. To prevent dependency errors in the interconnected module architecture, a diagnostic module executed by any one of the virtual machines 104 or servers 110 may be used as a substitute for one or more inactive service modules and receive or intercept messages and/or items directed to the inactive service module(s). The diagnostic module may generate alerts, error reports and/or repair activity triggers based on detecting inactive service module(s).

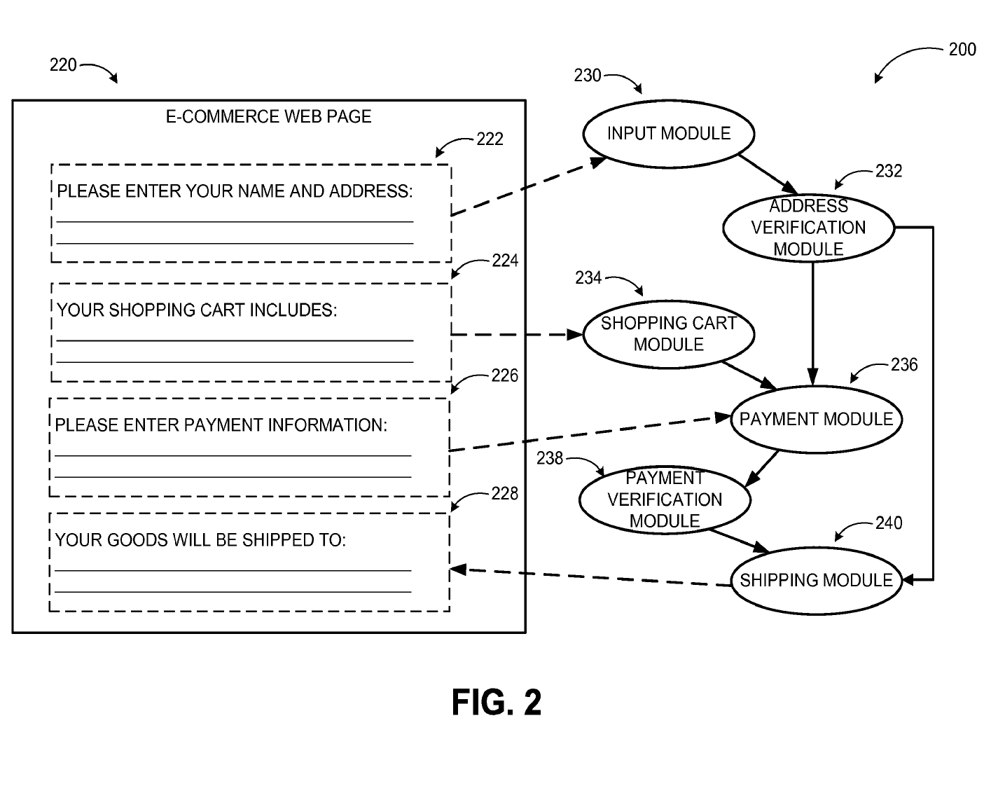

FIG. 2 illustrates use of interconnected modules in conjunction with an example e-commerce web page, arranged in accordance with at least some embodiments described herein.

As shown in a diagram 200, an e-commerce web page 220 may be displayed to a customer (e.g., one of the customers 108 in FIG. 1) while the customer is engaged in an online retail transaction. The web page 220 may include one or more interactive fields or elements for a customer to enter and/or view data. Each of the interactive fields or elements may then provide data to or retrieve data from one or more software modules. For example, an interactive field 222 may allow a customer to enter name and address information and provide the entered name and address information to an input module 230. The input module 230 may process the entered name and address information and forward the information to an address verification module 232, which may examine the forwarded (received) information to determine if the address is valid. An interactive field 224 may retrieve data about items in the customer's virtual shopping cart from a shopping cart module 234 and display the data to the customer. The shopping cart module 234 may also determine the total cost of the items in the shopping cart, for example.

An interactive field 226 may allow a customer to enter payment information and provide the entered payment information to a payment module 236. The payment module 236 may also collect address information from the address verification module 232 and cost information from the shopping cart module 234, and forward the collected information to a payment verification module 238. The payment verification module 238 may then determine if the payment information provided via the interactive field 226 is valid (e.g., if the information is correct, if it matches the name and address information provided via the input module 230, if it is sufficient to cover the cost of the items in the customer's shopping cart, etc.). A shipping module may then collect information from the payment verification module 238 and the address verification module 232 to generate shipping information, which may be displayed to the customer in an interactive field 228.

In some embodiments, the interconnected software modules described above may be implemented in a datacenter architecture. For example, a particular software module may be implemented as a process or application executed on one or more virtual machines (e.g., the virtual machines 104 in FIG. 1). While the diagram 200 depicts an example e-commerce web page 220, in other embodiments other web pages or online services that are supported by datacenter modules or modular functions may be provided to customers.

In applications that rely on interconnected software modules, such as the e-commerce web page 220 described in FIG. 2, each software module may send data to or receive data from one or more of the other modules. For example, the input module 230 may send data to the address verification module 232, which in turn may send data to the payment module 236 and the shipping module 240. In some examples data may be sent as API calls, as entries on a messaging system such as a queue, as JSON or XML objects, or as other forms of data. The payment module 236 may also receive data from the shopping cart module 234, and send data to the payment verification module 238. The shipping module 240 may receive data from the payment verification module 238 and the address verification module 232. These connections or dependencies between modules may affect system behavior if one or more of the modules become unavailable. For example, if the address verification module 232 becomes unavailable, then data transmitted from the input module 230 may be lost. Moreover, the payment module 236 and the shipping module 240 may be unable to function properly without receiving data from the address verification module 232. As a result, the e-commerce website 220 may become inoperative.

In another example scenario, one or more of the service modules may be replaced with another module, but the replacement may not be properly relayed to all modules in the system. Thus, some modules may still forward messages (data) to the replaced module breaking a flow of information.

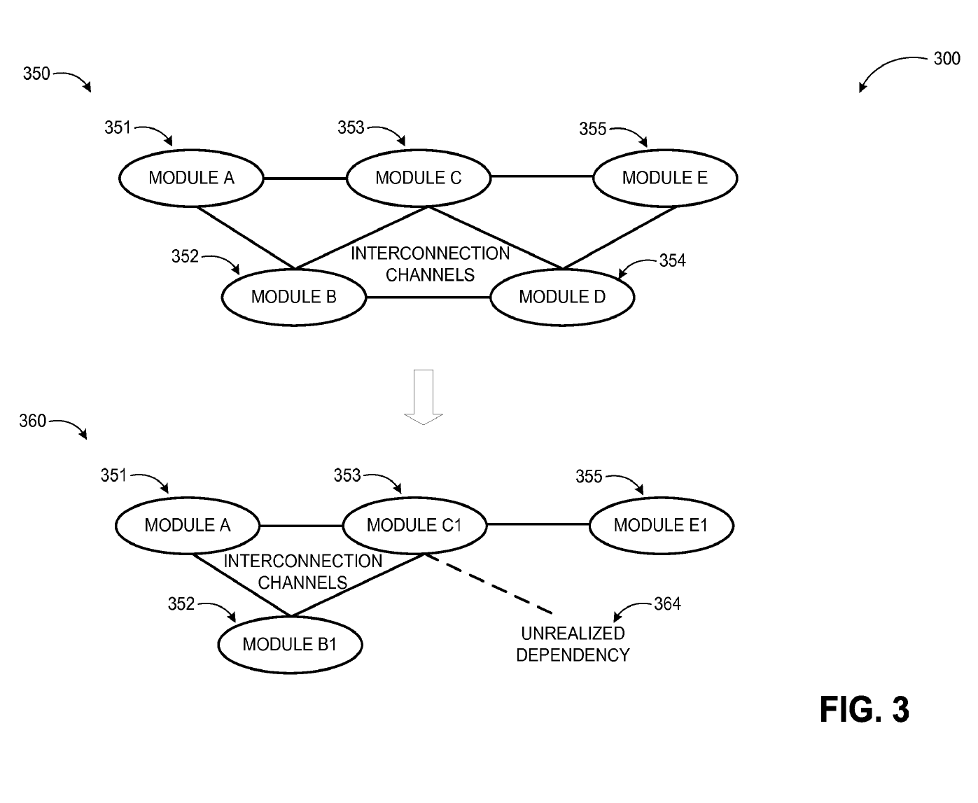

FIG. 3 illustrates an example datacenter module system, where deactivation of a module may result in unrealized dependency, arranged in accordance with at least some embodiments described herein.

As shown in a diagram 300, a datacenter module system 350 may include one or more software modules, each of which may be linked to one or more other software modules via interconnection channels. For example, a module 351 may be linked to a module 352 and a module 353. The module 352 may itself be linked to the module 353 and a module 354, in addition to being linked to the module 351. Similarly, the module 353 may be linked to the module 354 and a module 355, in addition to being linked to the module 351 and the module 352. The module 354 and the module 355 may additionally be linked to each other. Each module may communicate with linked modules via interconnection channels that may involve, for example, hypertext transfer protocol (HTTP) commands such as GET or POST, messaging/queuing systems in the datacenter, or any other suitable communication methods.

However, one or more of the interconnected software modules may be eliminated or deactivated for a variety of reasons (e.g., maintenance, upgrade, etc.). A module may fail, or the module system may be reconfigured to use different modules or replace preexisting modules. For example, the datacenter module system 350 may be modified to a similar datacenter module system 360. The datacenter module system 360 may have been modified to eliminate the module 354, by reconfiguring the module 352 and the module 355 to remove dependencies associated with the module 354. Moreover, the module 353 may be configured to operate in a regime that does not require the module 354. However, if mistakes are made in determining the correct dependencies, or if the module 353 unexpectedly ends up operating in a regime that requires the module 354, an unrealized dependency 364 may be introduced into the datacenter module system 360. As described above, such unrealized dependencies may result in difficult-to-trace errors, undesirable behavior, performance degradations, or even security leaks.

To address these unrealized dependencies, a diagnostic module may be provided that stands in for any removed or inactive service(s) or software module(s). The diagnostic module may be configured to capture messages in the interconnection channels directed to the now inactive module(s), or without a destination, for error-tracking or repair purposes. For example, the diagnostic module may be configured to record the captured messages, log errors, generate error reports, attempt remediation measures, and/or provide notifications of captured messages/requests and associated inactive modules. Therefore, messages that may have caused unanticipated behaviors, unexplained errors, or performance degradations can be captured and resolved.

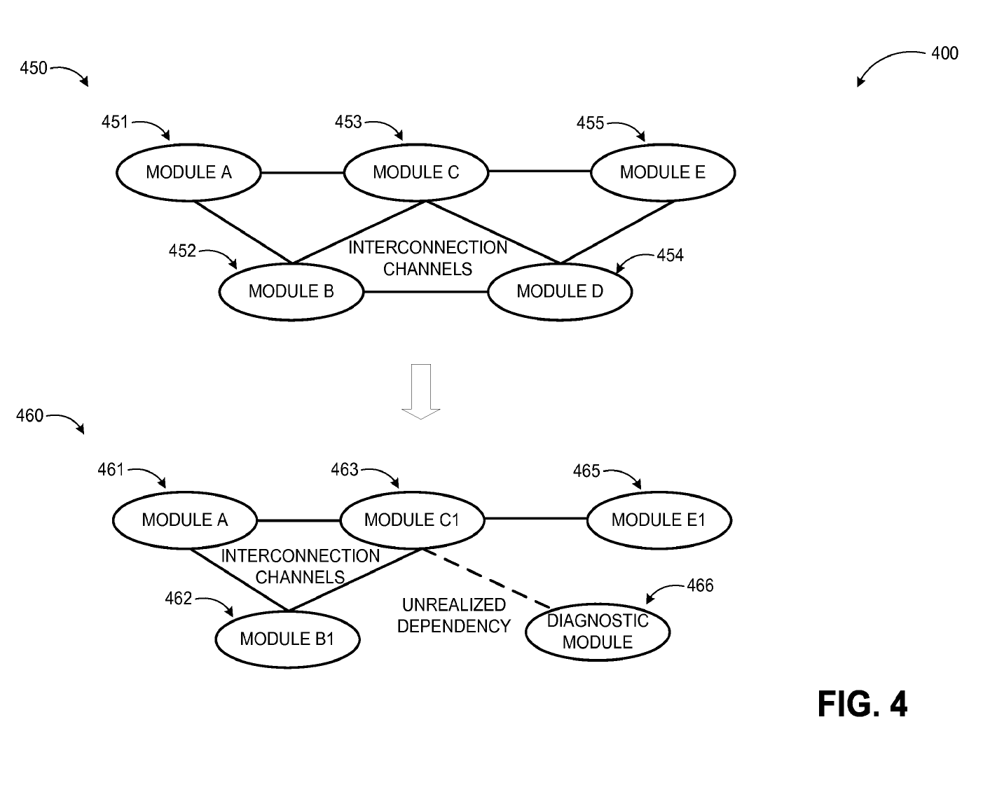

FIG. 4 illustrates another example datacenter module system, where a diagnosis module may be employed for error-capturing service replacement to simplify application restructuring, arranged in accordance with at least some embodiments described herein.

As shown in a diagram 400, a datacenter module system 450 may include software modules 451, 452, 453, 454, and 455, similar to the software modules 351, 352, 353, 354, and 355, respectively, described above in FIG. 3. Each of the software modules in the datacenter module system 450 may be linked to one or more other software modules via interconnection channels. As with the datacenter module systems 350 and 370 described in FIG. 3, the datacenter module system 450 may be modified to a similar datacenter module system 460, where the software module 454 has been eliminated. However, to account for any unrealized or unexpected dependencies that may occur as a result, the datacenter module system 460 may also include a diagnostic module 466. The diagnostic module 466 may be configured to receive messages intended for the software module 454, for example by checking message queues previously serviced by the module 454. The diagnostic module 466 may also act as a receiver for particular resolution of services previously involving the module 454.

While the diagnostic module 466 in FIG. 4 only stands in for a single module (i.e., the software module 454), in some embodiments a single diagnostic module may stand in for multiple eliminated modules. In such embodiments, each time a software module or service is shut down or eliminated, the connections addressed to the eliminated module/service may be rerouted to the diagnostic module. For example, messages and requests may be rerouted via forwarding, resolving requests at a domain name service (DNS), or having the diagnostic module check message queues. Therefore, a single diagnostic module may be used per user and/or domain. A higher level diagnostic module may also be provided to multiple users by the datacenter or a service provider, by those users submitting queues and addresses to monitor as they remove modules. Moreover, since messages to eliminated modules may be rare, the diagnostic module may not need to provide any services or computation, and therefore may be configured to be low-overhead, with minimal resources. In some embodiments, the diagnostic module may be a service that may receive new queues and addresses to check while running (e.g., by writing the received queues/addresses to a configuration file and adding them to a list of checks to perform). The diagnostic module may also be configured to trigger one or more repair activities, such as the removal of an inactive software module instance.

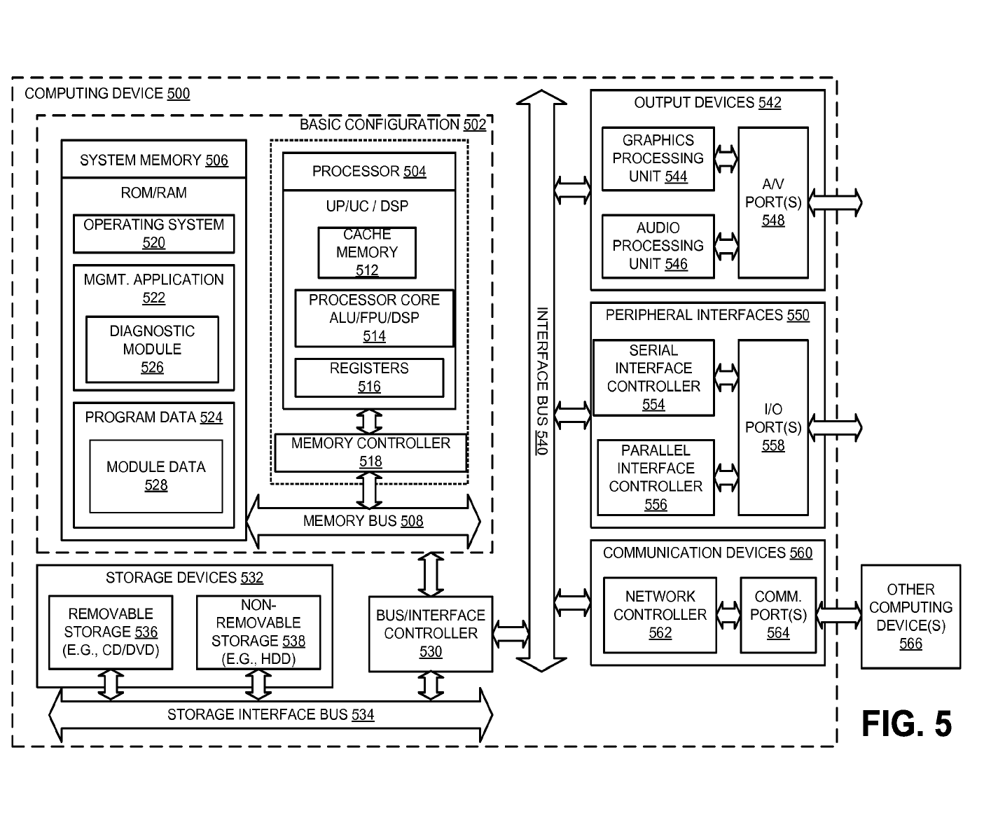

FIG. 5 illustrates a general purpose computing device, which may be used to manage error-capturing service replacement to simplify application restructuring, arranged in accordance with at least some embodiments described herein.

For example, the computing device 500 may be used to manage error-capturing service replacement to simplify application restructuring as described herein. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof The system memory 506 may include an operating system 520, a management application 522, and program data 524. The management application 522 may include a diagnostic module 526 for performing error-capturing service replacement to simplify application restructuring as described herein. The program data 524 may include, among other data, module data 528 or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 530. Some of the example output devices 542 include a graphics processing unit 544 and an audio processing unit 546, which may be configured to communicate to various external devices such as a display or speakers via one or more AN ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 560 includes a network controller 562, which may be arranged to facilitate communications with one or more other computing devices 566 over a network communication link via one or more communication ports 564. The one or more other computing devices 566 may include servers at a datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods for managing error-capturing service replacement to simplify application restructuring. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

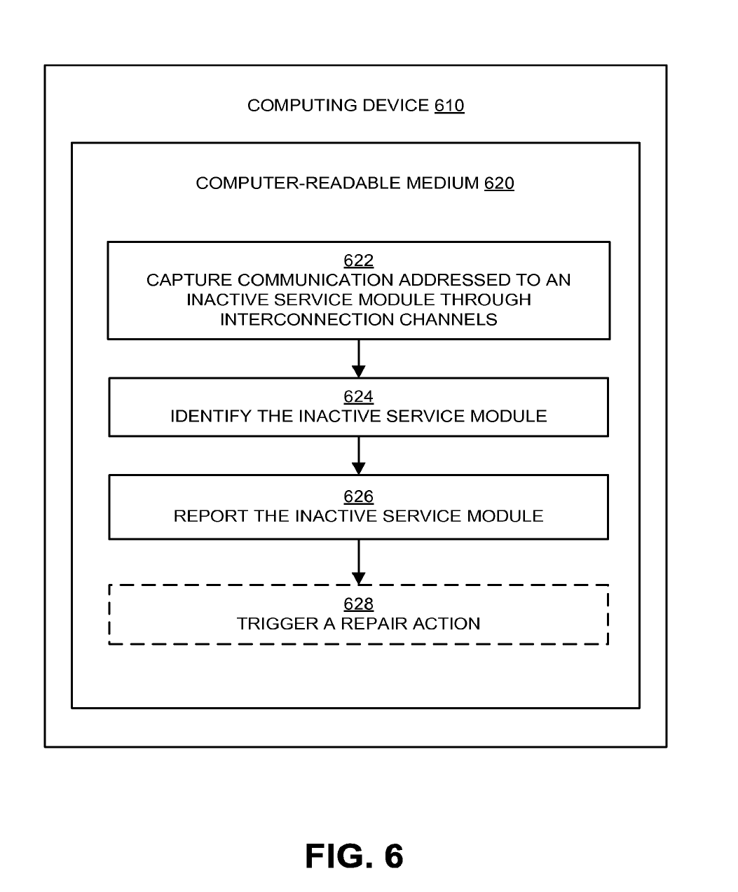

FIG. 6 is a flow diagram illustrating an example method that may be performed by a computing device such as the device in FIG. 5, arranged in accordance with at least some embodiments described herein.

Example methods may include one or more operations, functions or actions as illustrated by one or more of blocks 622, 624, 626, and/or 628, and may in some embodiments be performed by a computing device such as the computing device 500 in FIG. 5. The operations described in the blocks 622-628 may also be stored as computer-executable instructions in a computer-readable medium such as a computer-readable medium 620 of a computing device 610.

An example process for managing error-capturing service replacement may begin with block 622, “CAPTURE COMMUNICATION ADDRESSED TO AN INACTIVE SERVICE MODULE THROUGH INTERCONNECTION CHANNELS”, where messages directed via interconnection channels to an inactive service module (e.g., the eliminated software modules 354 and 454 in FIGS. 3 and 4) may be captured by a diagnostic module (e.g., the diagnostic module 466 in FIG. 4). In some embodiments, the diagnostic module may receive the messages directly, or may check message queues for messages to the inactive module.

Block 622 may be followed by block 624, “IDENTIFY THE INACTIVE SERVICE MODULE”, where the inactive service module, to which the captured messages are directed, may be identified by the diagnostic module 466.

Block 624 may be followed by block 626, “REPORT THE INACTIVE SERVICE MODULE”, where the diagnostic module 466 may report the inactive service module. For example, the identity of the inactive service module may be reported to an error-tracking service/module, or the identity of the inactive service module may be logged to an error log file.

In some embodiments, block 626 may be followed by optional block 628, “TRIGGER A REPAIR ACTION”, where one or more repair actions may be triggered by the diagnostic module 466. For example, the repair action may include removing dependencies to the inactive module from a module or removing an instance of the inactive module from the system.

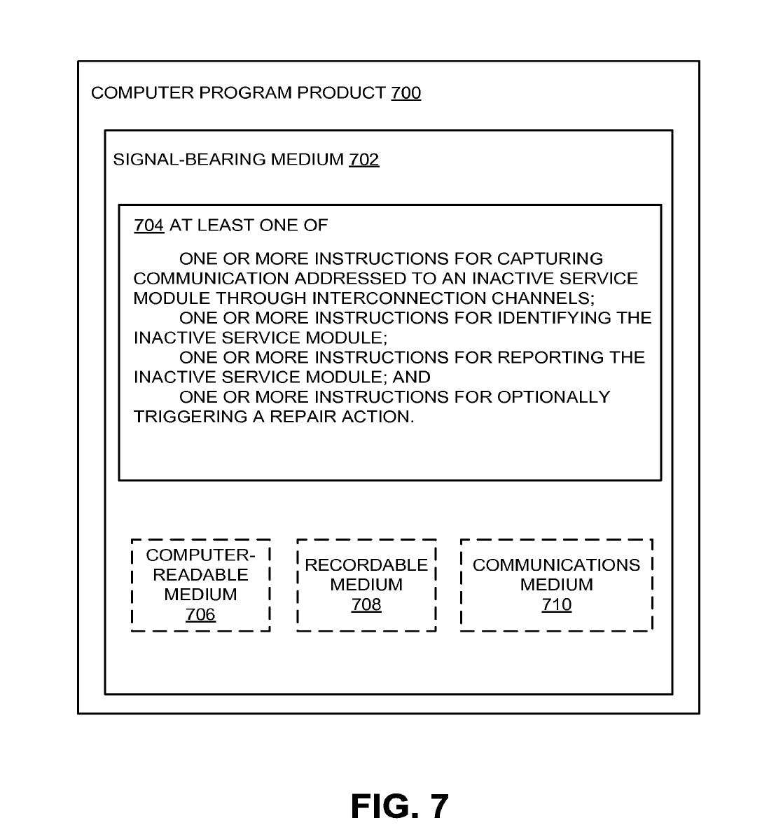

FIG. 7 illustrates a block diagram of an example computer program product, arranged in accordance with at least some embodiments described herein.

In some examples, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, the management application 522 may undertake one or more of the tasks shown in FIG. 7 in response to the instructions 704 conveyed to the processor 504 by the medium 702 to perform actions associated with managing error-capturing service replacement to simplify application restructuring as described herein. Some of those instructions may include, for example, capturing communication addressed to an inactive service module through interconnection channels, identifying the inactive service module, reporting the inactive service module, and/or optionally triggering a repair action, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 704 by an RF signal bearing medium, where the signal bearing medium 702 is conveyed by the wireless communications medium 710 (e.g., a wireless communications medium conforming with the IEEE 802.11 standard).

According to some examples, a method for error-capturing service replacement in a datacenter environment may include detecting communication addressed to an inactive service module within a datacenter architecture comprising a plurality of interconnected service modules and reporting the communication addressed to the inactive service module.

According to some embodiments, the method may further include monitoring message queues for one or more messages and requests directed at the inactive service module and/or capturing one or more of messages and requests without a destination within the multiple interconnection channels. The messages and requests may include one or more of GET commands and POST commands according to hypertext transfer protocol (HTTP).

According to other embodiments, the method may further include rerouting messages and requests intended for the inactive service module to a diagnostic module that is adapted to capture the communication and report the inactive service module. The method may also include rerouting the messages and requests by resolving a request at a domain name service (DNS) to the diagnostic module of a client whose instance is making the request. One instance of the diagnostic module may be provided per client and per domain. In other examples, a system may detect the messages and requests directed to one or more inactive service modules associated with multiple clients. For example, a datacenter may execute a service where any client may register queues and address names for service modules whenever they shut down or deactivate. The clients may register such information with a message through an application programming interface (API) offered by the datacenter or through an administrative panel. Relevant messages may then be captured as described herein. The datacenter may provide such a service for a fee or offer it as an infrastructure feature. The method may further include removing an instance of the inactive service module from service by transferring interconnection channels associated with the inactive service module to the diagnostic module. The method may also further include recording captured messages and requests into an error log, triggering a repair activity, and/or providing a notification about a captured message or request and associated inactive service module.

According to other examples, a datacenter management service configured to employ error-capturing service replacement may include a diagnostic module and one or more communication modules configured to facilitate communications between multiple service modules through interconnection channels. The diagnostic module may be configured to detect communication addressed to an inactive service module and report the communication addressed to the inactive service module.

According to some embodiments, the diagnostic module may be further configured to monitor message queues for one or more messages and requests directed at the inactive service module and/or capture one or more of messages and requests without a destination within the interconnection channels. The messages and requests may include one or more of GET commands and POST commands according to hypertext transfer protocol (HTTP).

According to other embodiments, at least one of the communication modules may be configured to reroute messages and requests intended for the inactive service module to the diagnostic module. The messages and requests may be rerouted by resolving a request at a domain name service (DNS) to the diagnostic module of a client whose instance is making the request. One instance of the diagnostic module may be provided per client and per domain. The datacenter management service may be configured to remove an instance of the inactive service module from service by transferring interconnection channels associated with the inactive service module to the diagnostic module.

According to further embodiments, the diagnostic module may be further configured to record captured messages and requests into an error log and to report the error log, trigger a repair activity by reporting the inactive service module to the repair module, and/or provide a notification about a captured message or request and associated inactive service module. The diagnostic module may be a service that is configured to receive new definitions of queues and addresses to monitor and to write the new definitions to a configuration file. The diagnostic module may be further configured to add the new definitions to a list of checks regularly performed by the diagnostic module.

According to further examples, a computer-readable storage medium may store instructions for employing error-capturing service replacement in a datacenter environment. The instructions may include detecting communication addressed to an inactive service module within a datacenter architecture comprising a plurality of interconnected service modules and reporting the communication addressed to the inactive service module.

According to some embodiments, the instructions may further include monitoring message queues for one or more messages and requests directed at the inactive service module and/or capturing one or more of messages and requests without a destination within the multiple interconnection channels. The messages and requests may include one or more of GET commands and POST commands according to hypertext transfer protocol (HTTP).

According to other embodiments, the instructions may further include rerouting messages and requests intended for the inactive service module to the diagnostic module. The instructions may also include rerouting the messages and requests by resolving a request at a domain name service (DNS) to the diagnostic module of a client whose instance is making the request. One instance of the diagnostic module may be provided per client and per domain. The instructions may further include removing an instance of the inactive service module from service by transferring interconnection channels associated with the inactive service module to the diagnostic module. The instructions may also further include recording captured messages and requests into an error log, triggering a repair activity, and/or providing a notification about a captured message or request and associated inactive service module. The instructions may further include receiving new definitions of queues and addresses to monitor at the diagnostic module and writing the new definitions to a configuration file, and/or adding the new definitions to a list of checks regularly performed by the diagnostic module.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C,” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for error-capturing service replacement in a datacenter environment, the method comprising:
identifying an inactive service module within a datacenter architecture comprising a plurality of interconnected service modules communicatively coupled through a plurality of interconnection channels;
capturing one or more messages addressed to the inactive service module within the plurality of interconnection channels; and
reporting the communication addressed to the inactive service module to a diagnostic module.

2. The method according to claim 1, further comprising monitoring message queues for the one or more messages directed at the inactive service module.

3. (canceled)

4. The method according to claim 1, wherein the messages include one or more of GET commands and POST commands according to hypertext transfer protocol (HTTP).

5. The method according to claim 1, further comprising rerouting messages intended for the inactive service module to the diagnostic module that is adapted to capture the communication and report the inactive service module.

6. The method according to claim 5, further comprising rerouting the messages and requests by resolving a request at a domain name service (DNS) to the diagnostic module of a client whose instance is making the request.

7. The method according to claim 5, wherein one instance of the diagnostic module is provided per client and per domain.

8. (canceled)

9. (canceled)

10. (canceled)

11. (canceled)

12. A datacenter management service configured to employ error-capturing service replacement, the datacenter management service comprising:
one or more communication modules configured to facilitate communications between a plurality of service modules through interconnection channels; and
a diagnostic module configured to:
identify an inactive service module;
capture one or more messages addressed to the inactive service module within the interconnection channels; and
report the messages addressed to the inactive service module to an error-tracking module.

13. (canceled)

14. (canceled)

15. (canceled)

16. (canceled)

17. (canceled)

18. (canceled)

19. The datacenter management service according to claim 12, wherein the datacenter management service is configured to remove an instance of the inactive service module from service by transferring interconnection channels associated with the inactive service module to the diagnostic module.

20. The datacenter management service according to claim 12, wherein the diagnostic module is further configured to record captured messages into an error log and to report the error log to the error-tracking module.

21. The datacenter management service according to claim 12, further comprising a repair module, wherein the diagnostic module is further configured to trigger a repair activity by reporting the inactive service module to the repair module.

22. The datacenter management service according to claim 12, wherein the diagnostic module is further configured to provide a notification about a captured message and associated inactive service module.

23. The datacenter management service according to claim 12, wherein the diagnostic module is a service that is configured to receive new definitions of queues and addresses to monitor and to write the new definitions to a configuration file.

24. The datacenter management service according to claim 23, wherein the diagnostic module is further configured to add the new definitions to a list of checks regularly performed by the diagnostic module.

25. A computer-readable storage medium having instructions stored thereon for employing error-capturing service replacement in a datacenter environment, the instructions comprising:
identifying an inactive service module within a datacenter architecture comprising a plurality of interconnected service modules communicatively coupled through a plurality of interconnection channels;
capturing one or more messages addressed to the inactive service module within the plurality of interconnection channels; and
reporting the communication addressed to the inactive service module to a diagnostic module.

26. The computer-readable storage medium according to claim 25, wherein the instructions further comprise monitoring message queues for one or more messages directed at the inactive service module.

27. (canceled)

28. (canceled)

29. The computer-readable storage medium according to claim 25, wherein the instructions further comprise rerouting messages intended for the inactive service module to the diagnostic module.

30. The computer-readable storage medium according to claim 29, wherein the instructions further comprise rerouting the messages by resolving a request at a domain name service (DNS) to the diagnostic module of a client whose instance is making the request.

31. The computer-readable storage medium according to claim 29, wherein one instance of the diagnostic module is provided per client and per domain.

32. The computer-readable storage medium according to claim 29, wherein the instructions further comprise removing an instance of the inactive service module from service by transferring interconnection channels associated with the inactive service module to the diagnostic module.

33. (canceled)

34. The computer-readable storage medium according to claim 25, wherein the instructions further comprise triggering a repair activity.

35.-37. (canceled)
